(19) United States
(12) Patent Application Publication
(10) Pub. No.: US 2014/0261762 A1
(43) Pub. Date: Sep. 18, 2014

(54) PIPELINE HEATER

(71) Applicant: Certek Heat Machine Inc., Wembley (CA)

(72) Inventors: Jeremy Barendregt, Grand Prairie (CA); Calvin Barendregt, Grand Junction, CO (US); Caleb Barendregt, Wembley (CA)

(73) Assignee: Certek Heat Machine Inc., Wembley (CA)

(21) Appl. No.: 14/212,513

(22) Filed: Mar. 14, 2014

Related U.S. Application Data
(60) Provisional application No. 61/792,514, filed on Mar. 15, 2013.

(51) Int. Cl. F16L 53/00

(52) U.S. Cl. CPC F16L 53/002
USPC 137/334

(57) ABSTRACT

A system for heating fluid lines to prevent freezing and ice build up. A heated fluid line is utilized within the pipeline to achieve improved thermal transfer.

### CROSS-REFERENCE TO RELATED APPLICATIONS

This application claims the benefit of the priority date of U.S. Provisional patent application Ser. No. 61/792,514 filed Mar. 15, 2013, which is incorporated herein by reference in its entirety.

### FIELD OF THE INVENTION

This invention relates to preventing ice buildup in fluid transport pipes. More particularly, the invention relates to providing a heating a fluid to warm a fluid inside of large pipes.

### BACKGROUND OF THE INVENTION

In particular climates it is desired to heat, thaw and prevent the freezing of pipelines. The pipelines are used to transfer fluids across a distance, sometimes through areas of cold weather.

Presently, heat exchangers are used to keep the fluid in the pipeline from freezing. However, heat exchangers require that the fluid in the pipeline be flowing in order to be effective. Once the fluid stops moving, the heat exchanger is unable to heat the fluid thereby making the system ineffective.

Another method to heat fluid in a pipeline is to heat the exterior. This requires the installation of heated lines on the exterior surface of the pipe. However, these transfer lines are generally inefficient as much of the heat is lost to the ambient air.

Yet another method, is to insert a device into the line and use a vacuum to draw the fluid from the line. Once drained the fluid is heated and pumped back into the pipeline. This method is both very labor intensive and requires the special equipment such as vacuum trucks.

Therefore, a system for keeping high volumes of fluid from freezing is desired.

Further, a system for keeping fluids from freezing with minimal intervention (disassembly of pipelines, draining and down time) is desired.

Even further, a system to provide safe, continuous heat over long distances, and to easily and quickly thaw frozen pipe is desired.

### SUMMARY OF THE INVENTION

In one form the invention relates to a fluid heating system having a pipeline having a heating insert installed along the length of the pipeline. The heating insert having at least one connector being in communication with a heating line, the heating line being positioned within the diameter of the pipeline. Heated fluid passes through the connector and through the heating line to warm the fluid within the pipeline.

In another embodiment, the invention includes a fluid heating system with a pipeline having at least one heating line located within its inner diameter. A heating insert delivers heated fluid to the heating line through a connector, while another connector receives heating fluid returning from the heating line.

In yet another embodiment, the invention includes a fluid heating system with a pipeline having a first opening, a second opening, a first pipeline flange, a second pipeline flange and an inner diameter. A heating insert is connected to the pipeline and has an outer surface, an inner diameter, an opening on each end, two heating insert flanges, at least two connectors passing through the outer surface of the heating insert, at least one heating line, wherein the heating line has a proximal end, a distal end, and both an inlet and an outlet near the proximal end. The first and second pipeline flanges are attached to the two heating insert flanges to form a continuous pipe as between said pipeline and said heating insert. The at least one heating line resides within the continuous pipe of the pipeline. The proximal end of the at least one heating line is connected to two connectors of the heating insert, and its distal end terminates within an inside diameter of the pipeline. The heating line is connected to the two connectors to form a continuous heating line as between one of the connectors of the heating insert, the heating line itself, and the other connector.

### BRIEF DESCRIPTION OF THE DRAWINGS

The present invention is disclosed with reference to the accompanying drawings, wherein:

FIG. 1 is an expanded isometric view of a pipeline having a heating insert and heated fluid lines according to one embodiment;

FIG. 2 is a close up isometric view of the heating insert shown in FIG. 1;

FIG. 3 is an alternative isometric view of the heating insert shown in FIG. 1;

FIG. 4 is an interior view of the heating insert shown in FIG. 2;

FIG. 5 is an expanded isometric view of a pipeline having a heating insert and heated fluid lines according to another embodiment;

FIG. 6 is a close up isometric view of the heating insert shown in FIG. 5; and

FIG. 7 is a close up isometric view of the heating line shown in FIG. 5.

Corresponding reference characters indicate corresponding parts throughout the several views. The examples set out herein illustrates several embodiments of the invention but should not be construed as limiting the scope of the invention in any manner.

### DETAILED DESCRIPTION

Referring to FIGS. 1-4, there is shown the heating lines for integration with fluid pipes according to one embodiment. To heat the fluid in the pipeline 10, a heating insert 20 is connected between sections of pipeline to allow integration of the heating lines 30. Heated fluid enters through one of the connectors 23 and flows through a heating line 30, such as a pipe, before exiting through a connector on a second heating insert (not shown), constructed similarly as the heating insert 20. Thus, the heating line 30 is connected between two interior connectors 25, one at each of two heating inserts 20 connected inline into the same pipeline 10. As shown in FIG. 1, more than one heating line 30 may be so connected as between two heating inserts 20 each having more than one interior connector 25. Also as shown in FIG. 1, each heating insert 20 may include upstream and downstream facing interior connectors 25 matching additional heating inserts 20 connected inline into the pipeline 10 upstream and downstream from the heating insert 20 illustrated in FIG. 1. In one embodiment, a terminal heating insert 20 may include only an upstream or a downstream set of interior connectors 25. In yet another embodiment, each heating insert 20 may include only one upstream and one downstream interior connector 25, or only one of an upstream or downstream interior connector 25. As illustrated in FIG. 4, the heating insert 20 includes two connector pairs wherein one pair faces in one direction at a proximal end of the heating insert 20 and the other pair of interior connector 25 faces toward an opposite direction at a distal end of the heating insert 20. Either of these interior connector pairs may be connected as upstream or downstream connectors. The heating insert 20 itself is a pipe having connectors formed therein and may be referred to herein as a pipe or pipeline. Hence, both the heating insert 20 and the pipeline 10 are each shaped as cylinders and each include a longitudinal axis along their cylindrical centers which may be considered to be coaxial when the heating insert 20 is attached to the pipeline 10.

The heating insert 20 is connected in line with the pipeline 10. The pipeline flange 11 is the same diameter as the heating insert flange 21. The two flanges are connected together in a similar manner as connecting sections of pipeline, to form a leak-resistant seal and a continuous pipeline. This connection allows the flow of fluid through the pipeline and heating insert sections.

The heating insert 20 has at least one of connector 23 to allow transfer of heating fluid from the exterior of the pipeline into the interior of the pipeline without leaking heating fluid into the pipeline product itself. The connectors may be either inlet or outlet ports. It is understood that the heating insert may contain any number of connectors. In one embodiment, the heating insert has one inlet and one outlet connector. In another embodiment, the heating insert has two inlet and two outlet connectors. In yet another embodiment a first heating insert has one inlet port while a second heating insert has one outlet port. The connectors 23 pass through the heating insert 20 at the transition point 22 forming a closed loop that allows the connector to transfer fluid from the outside of the pipe to the heating line inside of the pipe and back out of the pipe through another connector. In one embodiment, the connector 23 further contains a shut off valve 24 to adjust or shut off the flow of heating fluid.

The interior connections 25 connect to the heating line connection 31 of the heating line 30. heating fluid flows through the connector 23 through the heating line 30 to a second connector (not shown) before exiting the system. In one embodiment, an auxiliary pump is used to increase, or provide an adequate flow rate of the heating fluid.

In another embodiment, the connectors are integrated directly into the pipeline 10, without the need for the additional heating insert 20. While the heating insert 20 allows for integration into existing pipelines, a pipeline with integrated connectors and heating lines is ideal for a new build.

In use, the multiple heating inserts are connected between sections of pipeline. The heating insert attaches to the pipeline in the same manner as connecting multiple pieces of pipeline to form a continuous pipe. Inside the pipeline resides at least one heating line to carry heating fluid through the pipeline. The heating fluid is completely contained within the heating line to prevent the heating fluid from mixing with the fluid in the pipeline. Each end of the heating line connects to connectors found on the heating inserts connected to each end of the pipeline. These connectors allow the heating fluid to be transferred from outside of the pipeline and into the heating line found inside the pipeline when the pipeline is fully assembled and closed. By the heating line residing inside of the pipeline a more efficient level of heat transfer can be obtained.

Referring to FIGS. 5-7, there is shown heating lines for integration with fluid pipes according to another embodiment. To heat the fluid in the pipeline 110, a second embodiment of a heating insert 120 is connected between sections of pipeline to allow integration of the heating lines 130. Heated fluid enters through one of the connectors 123 and flows through a heating line 130 before exiting another connector 126 on the heating insert 120. While the description below will describe operation of the heating insert 120 embodiment of FIGS. 5-6, it should be noted that the heating insert 20 shown in FIGS. 1-4 may also be used, with interior connections 25 therein for connecting to the heating line inflow and outflow connections 131, 132, respectively. The pipeline 110 of FIG. 5 is shown in a cutaway view to better illustrate the heating line 130 within the inside diameter of pipe 110.

The heating insert 120 is connected in line with the pipeline 110. The pipeline flange 111 is the same diameter as the heating insert flange 121. The two flanges are connected together in a similar manner as connecting sections of pipeline, to form a leak-resistant seal and a continuous pipeline. This connection allows the flow of fluid through the pipeline and the heating insert.

The heating insert 120 has at least one of connector 123 to allow transfer of heating fluid from the exterior of the pipeline into the interior of the pipeline without leaking heating fluid into the pipeline product itself. The heating insert 120 also has at least one of connector 126 to allow return transfer of heating fluid from the interior of the pipeline 110 to the exterior of the pipeline without leaking heating fluid into the pipeline product itself. The connectors 123, 126 may be arranged as either inlet or outlet ports. It is understood that the heating insert may contain any number of connectors. In one embodiment, the heating insert has one inlet connector 123 and one outlet connector 126. In another embodiment, the heating insert has two inlet and two outlet connectors. The connectors 123, 126 pass through the heating insert 120 at the transition point 122 forming a closed loop that allows the connector 123 to transfer fluid from the outside of the pipe to the heating line inside of the pipe and back out of the pipe through another connector 126. The connectors 123, 126 may further each contain a shut off valve (such as 24 as shown in FIGS. 1-4) to adjust or shut off the flow of heating fluid.

The interior connections 125 connect to the heating line inflow and outflow connections 131, 132, located near a proximal end of the heating line 130. Heating fluid flows through one connector 123 through the heating line inflow connection 131, which is the open proximal end of the small diameter interior pipe 133. The heating fluid flows through the small diameter pipe section 133 of the heating line 130 toward a distal end of the heating line, and returns via a return channel formed by the larger diameter pipe 134 to heating line outflow connection 132, then to another connector 126 before exiting the system. In one embodiment, an auxiliary pump is used to increase, or provide an adequate flow rate of the heating fluid. In an exemplary embodiment, the smaller diameter pipe 133 is a one inch pipe, and the larger diameter pipe 134 is a two inch pipe.

The heating line 130 is formed by positioning the smaller diameter pipe 133 within an inside diameter of a larger pipe 134. The proximal and distal ends of the larger diameter pipe 134 are closed off, or capped (distal end), so as not to permit the heating fluid to exit therefrom, except through fluid return outflow connection 132, as described below. Both the proximal and distal ends of the smaller diameter pipe are open. The proximal open end of the smaller diameter pipe 133 forms the heating line inflow connection 131 while the open distal end of the smaller diameter pipe 133 is positioned within the larger diameter pipe 134 and extends toward the closed distal end of the large diameter pipe. The open distal end of the smaller pipe does not make contact with the closed distal end of the larger diameter pipe so as to permit the heating fluid to exit from the distal end of the smaller diameter pipe 133. Pressure from the heating fluid exiting the open distal end of the smaller pipe 133 generates a return flow in the plenum formed between an outside surface of the smaller pipe 133 and the inside surface of the larger pipe 134 from the distal end of the heating line 130 back toward its proximal end. The proximal end of the larger pipe 134 is sealed against the smaller inner pipe 133 to prevent heating fluid from exiting therefrom. The proximal end of the larger pipe 134 includes an opening having a connector 132 attached thereto allowing the heating fluid to exit the heating line and for connecting to the interior connection 125 of the heating insert 120. The return heating fluid thereby exits the pipeline through connector 126. The distal end of the heating line may be propped against a bracket supported by an inside diameter of the pipeline 110. Similarly, the distal end of the smaller pipe 133 may be propped against a bracket on an inside diameter of the larger pipe 134.

The heating insert 120 may be connected to heating fluid supply in line with an upper flange 140. The heating fluid supply flange 141 is the same diameter as the heating insert upper flange 140. The two flanges are connected together in a similar manner as connecting the pipeline 110 to end flanges 121 of the heating insert 120 to form a leak-resistant seal and a continuous flow. A central axis of the flange 140 may be said to be substantially perpendicular to the longitudinal axis of the pipeline 110, while an axis of the flange 121 may be said to be substantially coaxial with the longitudinal axis of the pipeline 110 when the heating insert 120 is attached to the pipeline 110.

In another embodiment, the connectors are integrated directly into the pipeline 110, without the need for the additional heating insert 120. While the heating insert 120 allows for integration into existing pipelines, a pipeline with integrated connectors and heating lines is ideal for a new build.

The heating insert 120 attaches to the pipeline in the same manner as connecting multiple pieces of pipeline to form a continuous pipe. Inside the pipeline resides at least one heating line 130 to carry heating fluid through the pipeline. The heating fluid is completely contained within the heating line to prevent the heating fluid from mixing with the fluid in the pipeline. The connectors 131, 132 of the heating line 130 are connected to interior connections 125 of connectors 123, 126 found on the heating insert. These connectors allow the heating fluid to be transferred from outside of the pipeline and into the heating line found inside the pipeline when the pipeline is fully assembled and closed. By the heating line residing inside of the pipeline a more efficient level of heat transfer can be obtained.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

### PARTS LIST

10 pipeline

11 pipeline flange

20 heating insert

21 heating insert flange

22 transition point

23 connectors

24 shut off valve

25 interior connections

30 heating lines

31 heating line connection

110 pipeline

111 pipeline flange

120 heating insert

121 heating insert flange

122 transition point

123 heating insert inflow connectors

124 shut off valve

125 interior connections

126 heating insert outflow connectors

130 heating lines

131 heating line inflow connection

132 heating line outflow connection

133 heating line interior pipe

134 heating line exterior pipe

140 heating insert upper flange

141 heating fluid supply flange

1. A fluid heating system comprising:
a pipeline having first opening, a pipeline flange and an inner diameter;
at least one heating line located within the inner diameter of said pipeline; and
a heating insert having an outer surface, an inner diameter, an opening on each end, two heating insert flanges and comprising at least two connectors, a first one of said connectors for delivering heated fluid to the heating line and a second one of the connectors for receiving the heating fluid returning from the heating line.

2. The fluid heating system of claim 1 wherein said heating insert comprises at least four connectors for connecting to two heating lines.

3. The fluid heating system of claim 2 wherein a second one of the two heating lines is connected to two of the connectors and extends away from the heating insert in a direction opposite that of the at least one heating line.

4. The fluid heating system of claim 1 further comprising an auxiliary pump to deliver the heated fluid to said first connector.

5. The fluid heating system of claim 1 wherein said heating line, said first connector and said second connector form a closed loop.

6. A fluid heating system comprising:
a pipeline having a first opening, a second opening, a first pipeline flange, a second pipeline flange and an inner diameter;
a first heating insert having an outer surface, an inner diameter, an opening on each end, two heating insert flanges and comprising at least two connectors;
at least one heating line, the heating line having a proximal end, a distal end, and both an inlet and an outlet near the proximal end;
said first and second pipeline flanges being attached to corresponding ones of the two heating insert flanges to form a continuous pipe as between said pipeline and said heating insert, said at least two connectors passing through the outer surface of said heating insert;
said at least one heating line residing within the continuous pipe formed by said pipeline, said proximal end of said heating line being connected to said at least two connectors of said heating insert and said distal end of said heating line terminating within an inside diameter of the pipeline at a preselected length from the heating insert and being connected to said at least two connectors of said heating insert to form a continuous heating line between one of said at least two connectors of said heating insert and another connector of said at least two connectors.

7. The fluid heating system of claim 7 wherein said heating insert comprises at least four connectors.

8. The fluid heating system of claim 7 further comprising an auxiliary pump to deliver heated fluid to one of said at least two connectors.

9. The fluid heating system of claim 7 wherein said pipeline is a fluid pipeline.

10. The fluid heating system of claim 11 wherein said fluid pipeline is a liquid pipeline.

11. The fluid heating system of claim 7 wherein each of said at least two connectors comprises a shut off valve.

12. A heating insert comprising:
at least two flanges each configured to be connected to a matching flange of a pipeline; and
at least one exterior connector having an opening on an outside of the heating insert and at least one interior connector having an opening in an interior of the heating insert, the openings of the at least one interior and exterior connectors in fluid communication to form a fluid channel, and
wherein the at least one interior connector is configured to be connected to a heating line disposed inside the pipeline.

13. The heating insert of claim 12, wherein the at least one exterior connector is configured to receive a heating fluid through its opening for delivering the heating fluid through the heating line connected to the interior connector.

14. The heating insert of claim 13, wherein the at least one exterior connector comprises a manual shutoff valve for closing its opening and preventing the heating fluid from traveling therethrough.

15. The heating insert of claim 12, wherein the opening of the at least one exterior connector and the opening of its corresponding interior connector face a same direction along an axis of the heating insert.
